(19) United States
(12) Patent Application Publication
(10) Pub. No.: US 2003/0025736 A1
(43) Pub. Date: Feb. 6, 2003

(54) Apparatus, method and computer software product for analyzing the operation of complex systems

(76) Inventor: Rainer Kuth, Herzogenaurach (DE)

Correspondence Address: SCHIFF HARDIN & WAITE, 6600 SEARS TOWER, 233 S WACKER DR, CHICAGO, IL, 60606-6473, US

(21) Appl. No.: 10/199,274

(22) Filed: Jul. 19, 2002

(30) Foreign Application Priority Data
Jul. 19, 2001 (DE) 10135287.5

(51) Int. Cl. G09G 5/00

(52) U.S. Cl. 345/772

(57) ABSTRACT

In a method, apparatus and computer software product for monitoring the operation of program-controlled devices, the formal parameters resulting from a use of input aids are logged as are the logical parameters triggered in programs of the program-controlled device as a result of the use of the input aids, and the formal and logical parameters are linked to form a monitoring profile. A data output is determined from the monitoring profile according to designated criteria.

### BACKGROUND OF THE INVENTION

1. Field of the Invention

The present invention is directed to a method, to a computer software product and to an apparatus for monitoring the operation of program-controlled equipment, particularly for monitoring the operation of a controller of a tomographic medical device that functions based on a computer program.

2. Description of the Prior Art

Complex machines and systems such as, for example, radiological examination devices require a number of settings on the part of an operator. The control of these machines and systems is usually realized with computer programs. Complex inputs and manipulations of data are required from the operator in order to undertake the desired settings. As experience shows, however, the level of training and the dexterity of the individual operators differ radically. Controllers that are implemented in program-oriented fashion offer complex user interfaces that often allow special setting possibilities that specifically facilitate the use of a machine or system for specific applications such as, for example, in a radiological laboratory.

For a radiological examination device such as, for example, a magnetic resonance tomograph, an operator must enter approximately 30 parameters for a measurement sequence. Some of these parameters are in relationship to one another, so that the value of one parameter directly influences the value of a second parameter. The repetition time of an installation for magnetic resonance tomography, for example, is directly linked in this sense to the number of registered slices.

The effective operation of complex systems requires not only well-trained operating personnel but also an operating structure that enables a rational implementation of the settings, with the professional background knowledge of the operating personnel also being considered. The efficiency of the operation of a complex system is influenced by the educational level of the individual operators and is also influenced by the manner in which operators can undertake settings at the system.

How well an operator will manage with a complex system is generally difficult to evaluate since objective evaluation criteria usually cannot be adequately determined and usually are overlaid by subjective criteria. Further, some input structures occasionally do not correspond to the standard viewpoint for a specific technical application. A user can then not make the settings in conformity with the user's accustomed approach but is forced to rethink the matter, the time for undertaking the required setting being lengthened as a result. Misunderstandings also occur frequently, so that settings that have already been made must be revised later.

### SUMMARY OF THE INVENTION

An object of the present invention to provide a method, a computer software product and an apparatus that supply objective data for evaluating the efficiency of the operation of complex machines and systems.

This object is achieved in a method for monitoring the operation of program-controlled devices including method steps of logging the formal parameters resulting from a use of input aids and the logical parameters triggered in programs of the program-controlled device as a result of the use of the input aids, linking the formal and logical parameters to form a monitoring profile, and for outputting data that are determined from a monitoring profile according to designated criteria. As used herein a formal parameter is a parameter that results from the operation of input aids for undertaking settings, resulting either directly therefrom or mediated via the operating system of a computer-controlled system. For example, a formal parameter describes a specific action at an input aid such as, for example, pressing a specific key on a keyboard or a movement of a mouse. A logical parameter indicates values and functions that are defined in a program such as, for example, a function like “show/mask image texts” or a value like “date of birth”.

The above object also is achieved in a computer software product for monitoring the operation of program-controlled devices having a first registration routine for registering the formal parameters resulting from a use of input aids, a second registration routine for registering the logical parameters triggered in programs of the program-controlled device as a result of the use of the input aids, a logic routine for linking the formal parameters that have been registered and the logical parameters that have been registered to form a monitoring profile, and an output routine for outputting data that are determined from the monitoring profile according to designated.

The object of the present invention also is achieved in an apparatus for monitoring the operation of program-controlled devices having units for the execution of computer programs, and including the execution of an aforementioned computer program.

The information about the significance of an input parameter is linked in the present invention to the events necessary to achieve it. The output of the data according to designated criteria allows a filtering of the logged input parameters for a meaningful evaluation of the productivity of the operation but also for a meaningful evaluation of the manner of employing the complex machine or system

Advantageously, the logging of the formal parameters ensues in an event-controlled manner, so that the registration of an input parameter is triggered by the operating event itself. Formal and logical parameters preferably are logged together with the point in time they were generated, so that the sequence of inputs can be exactly reconstructed. An operator-specific logging of formal and logical parameters advantageously enables monitoring to evaluate the productivity of individual users. Also advantageously, formal parameters contain details about the type of input aid, so that preferred input aids and/or the manner of their use can be evaluated. For a system-specific interpretation of the data of the monitoring profiles, a monitoring profile preferably contains details about the program-controlled device on which it is produced.

In an embodiment of the present invention, data are determined from a monitoring profile according to the criterion of a repeated triggering of identical logical parameters and/or according to the criterion of an undo of previously triggered logical parameters. This allows specific input possibilities that could lead to confusion on the part of operators to be filtered out. Preferably, data also are determined from a monitoring profile according to the criteria of an attempted input of illegal value combinations, making it possible to judge whether the input possibilities correspond to way the operator envisions the scenario. Advantageously, data also are determined from a monitoring profile according to the criteria of a time span between the triggering of two logical parameters, so that a judgment can be made regarding input steps that lead to delays in the operation of the system.

The present invention can be employed at all complex machines and systems that require extensive inputs, settings and manipulations of data on the part of an operator, so that a check of the efficiency of the operation of the system is desired. First, the present invention is employed in checking the training level of operating personnel, so that if there is a need for training, this can be recognized. Second, the invention serves the purpose of determining data that make it possible for a manufacturer to review the acceptance of the program-guided control or parts thereof as well as the way its is applied. The present invention therefore serves for increasing the productivity of the user as well as the productivity of the developer.

### DESCRIPTION OF THE DRAWINGS

FIG. 1 (formed by a combination of FIGS. 1A and 1B) illustrates the logging of inputs by operating personal in accordance with the invention in a simplified example;

FIG. 2 (formed by a combination of FIGS. 2A and 2B) illustrates the evaluation of a monitoring log according to designated in accordance with the invention.

FIG. 3 is a block circuit diagram of an inventive device for monitoring the operation of program-controlled devices in accordance with the invention.

### DESCRIPTION OF THE PREFERRED EMBODIMENTS

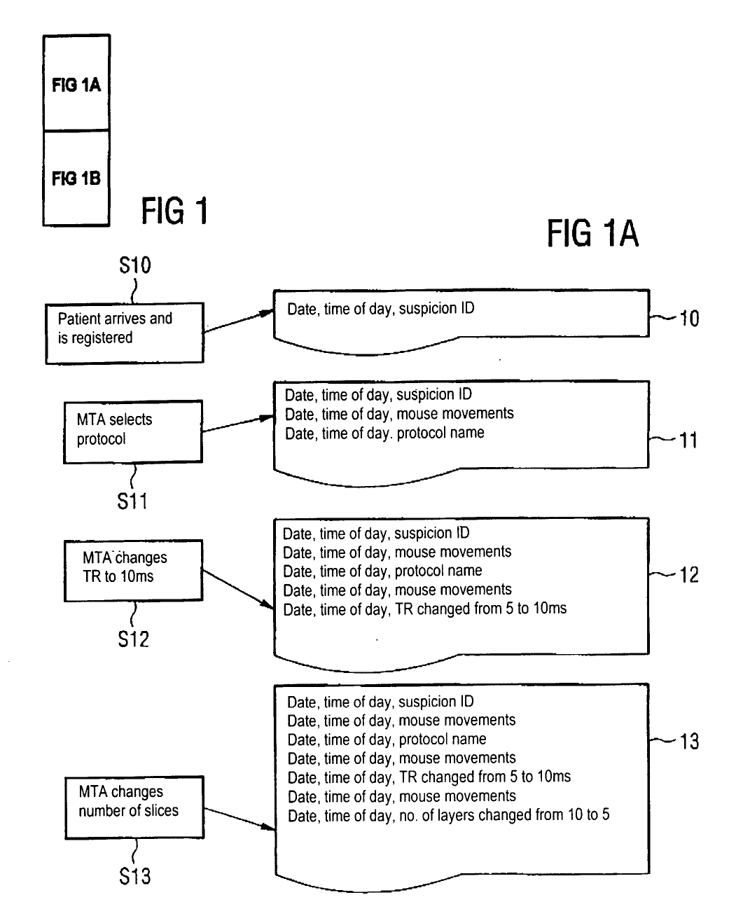

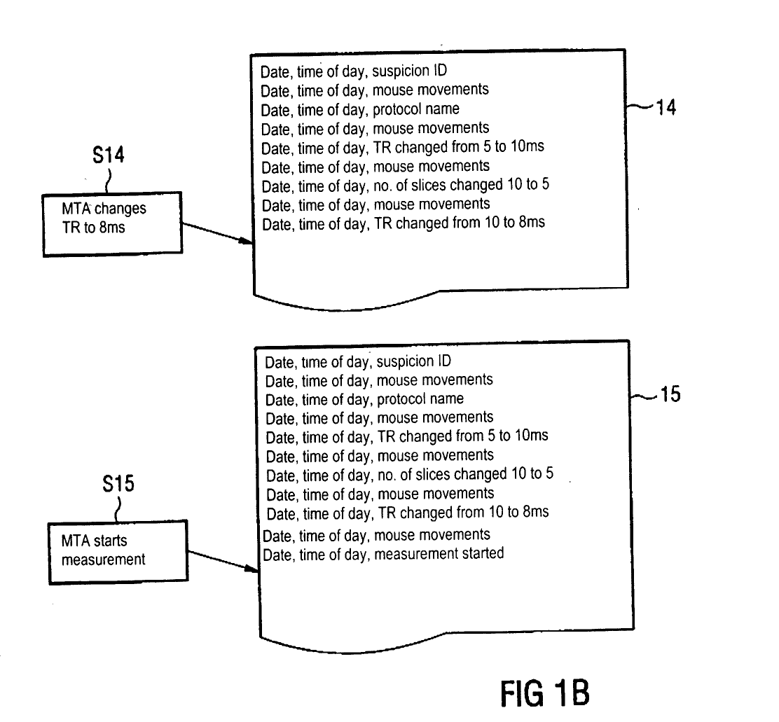

The principle of the inventive registration of a monitoring profile is shown in FIG. 1. The operating steps of an operator—a medical technical assistant (MTA) in the example—are listed at the left side; the logging of the input parameters that ensued as a result of the operation is shown at the right side. Since complex systems such as, for example, radiological examination facilities are employed for very different examination methods, initial parameters preferably also are retained in the log. The initial parameters contain data about the patient registration such as, for example, the patient's last name, patient number, date of birth, sex, weight, the nature of the suspected medical problem and the examination method as well as the patient's situation and the like. All inputs are retained with date and time of day. The precision of the registration of the time of day is based on the required analysis and can be defined exactly to a tenth of a second.

In addition to the data of the patient registration data, the log also preferably contains data that provide information about the user of the system, for example the radiological laboratory or the corresponding department in a clinic, as well as data about the system on which the respective log is produced. Data for specifying the current operator either can be directly requested as an input or can be read out from the logon data of the control program.

After the initial parameters have been logged in step S10 with indication of the date and time of day in the first step of the log or monitoring profile 10, the medical technical assistant selects a suitable measurement protocol in step S11. The monitoring profile 10 is thereby expanded by the registration of the mouse movements implemented for this purpose and by the name of the selected protocol, so that it has the form of the log 11. In the next operating step S12, the MTA changes the repetition time (TR) to 10 ms. The monitoring log is expanded to the form of the log 12 that, compared to the form 11, contains the new formal parameters—in the example, the mouse movements required for the input and the logical parameters that have been triggered, namely the change of the repetition time (TR) from 5 to 10 ms. In the following step S13, the medical technical assistant changes the value for the number of slices. Correspondingly, the log—in the form 13—contains the mouse movements implemented by the MTA for this purpose and an entry about the change of the number of slices, i.e. the number of tomograms to be registered during the measurement from the original 10 to 5. In step S14, the operator again changes the repetition time (TR), this time to 8 ms. The log is correspondingly expanded in the form 14 in conformity with the mouse movements needed for this and by the indication of the change of the repetition time from 10 ms to 8 ms. Finally, the medical technical assistant starts the actual measurement in step S15. In the form 15, the monitoring profile contains the mouse movements needed for this in addition to the entries of the form 14 and the indication that the measurement was started.

It is assumed in the example of FIG. 1 that all inputs were undertaken using a mouse device. Usually, the operating personnel have a number of supplementary and/or alternative input aids available. The keyboard can be employed for navigation over the input masks of a controller realized in program-oriented fashion as well as for the input of specific values. It is advantageous to retain which keys are used for navigation. For example, input fields can be selected with the tab key but also with the arrow keys of the keyboard. Given graphic user interfaces, a mouse device preferably is employed since input fields or switch buttons thus can be directly selected.

When it is difficult for a user to identify a specific graphic object that the user would like to access, then either a longer time span than usual elapses until the corresponding object is selected or—especially when selecting buttons whose graphic symbols are not immediately apparent to the user—relatively random movements of the mouse pointer over the graphic interface will occur. The registration of the mouse movements as well as the retention of the time of day or time duration at which specific actions were implemented thus implicitly contains information about the clarity of an input mask for a user.

The control of the log entries ensues in an event-controlled manner via the operation of the input aids. Preferably, the triggering of an input parameter is recognized and logged by means of an interrupt instruction initiated with a corresponding input aid.

Certain input aids are more accommodating to the work of an operator than others. For example, an operator can be overtaxed by a complex structure of the graphic interface as displayed on the picture screen. In particular, locating a submenu point from the main menu can be a time-consuming event for an unpracticed user. Many menu functions therefore are presented as graphic buttons that are arranged in logical groups. This, too, nonetheless can lead to an overload of information on the picture screen that confuses the user. Many users therefore prefer a pad as input aid on which selected commands are imaged that can be activated with a magnifying glass and in response to which the mouse pointer in a specific region on the picture screen can be driven to the absolute coordinates. Force-based input aids are better suited than path-based ones for specific inputs such as, for example, the modification of a slice orientation, since they convey the impression that the change or the speed of the change is directly influenced by the force exerted by the user. Thus, for example, the turning of a slice attitude can be slowly modified by exerting a slight force is exerted on the input device, whereas the change of the slice attitude proceeds faster given application of a greater force.

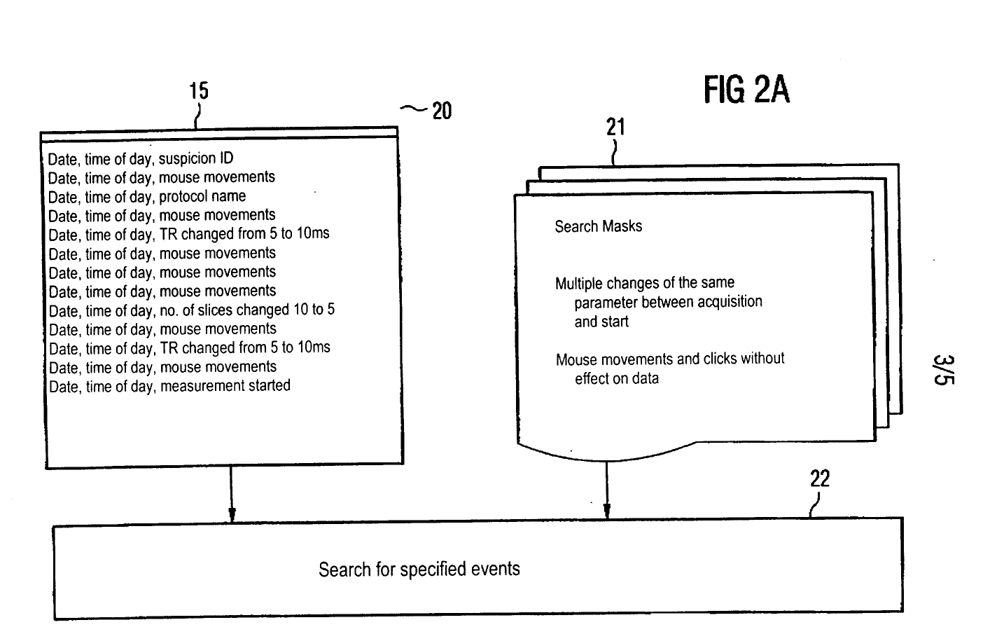

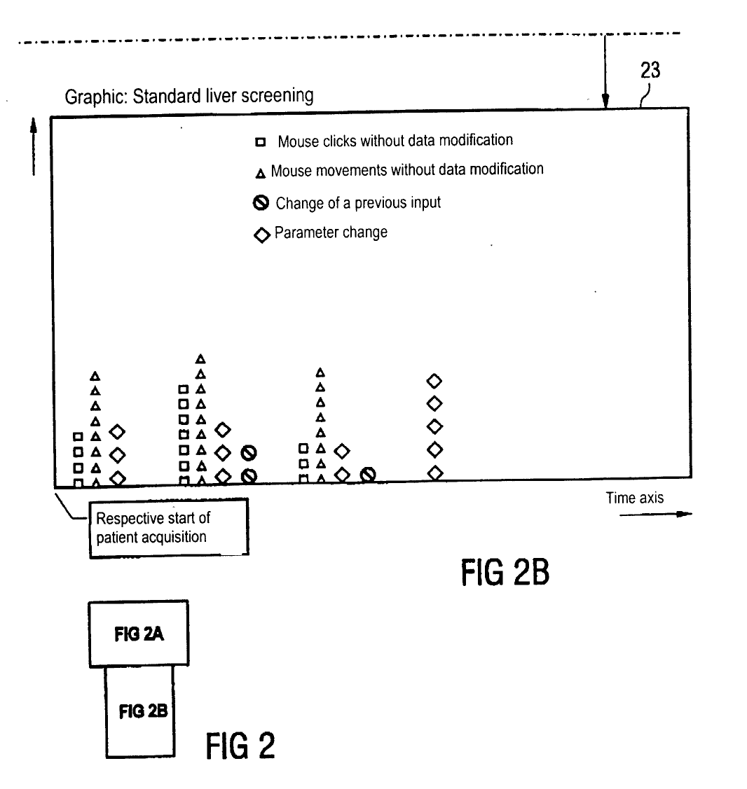

FIG. 2 schematically reproduces an inventive analysis protocol 20 for a monitoring log. The output of the data 23 ensues via a search 22 for specified events in the monitoring log 15. The search 22 for specified events reduces the data registered in the monitoring log according to a filter defined by the search criteria. The result is output in the graphic 23 with the abscissa being a time axis and the ordinate being for the listing of equivalent formal or logical parameters.

The search criteria to be defined for the search 22 for specified events are based on the task that has been imposed. When, for example, one seeks to find whether certain operators still have a need for training with respect to the technological comprehension or the effective utilization of the input aids, then a filtering of the data of the monitoring profiles according to the following criteria is recommendable undoing or modifying a previous input, modifying linked parameters independently of one another, employing an input aid without data modification, time difference between two inputs greater than a specific value and the like. The result of the filtering of the monitoring profile can then be output in the graphic 23 isolated for each user or—in order to obtain statistical data—can be output in a form ordered according to devices or individual radiological laboratories. Preferably, the beginning of an operating sequence is defined as the origin of the time axis. In order to obtain a diagnostically significant design of the graphic 23, the individual events are not entered directly as a function of the point in time of their occurrence, rather the formal as well as logical parameters are combined for each operating unit of the input event, so that the sum of the parameters meeting a specific criterion can be confined to one operating unit. The formal and logical parameters filtered for each operating unit are grouped on the time axis according to the time occurrence of the operating unit.

The search criteria produced for a specific evaluation of a monitoring profile can be combined in search masks 21 and stored. A set of monitoring profiles thus can be filtered in a simple way according to various evaluation criteria in that the corresponding search masks are called. The search masks can be labeled with suitable topics, so that, for example, a search mask “misinterpreted menu points” contains a definition of search criteria that enables the locating of menu points that are often misunderstood.

The search masks also enable an analyst to extract data about the evaluation of the operation of one or more system from the monitoring profiles without having to be familiar with the technique of producing search criteria. The present invention thus allows a statistical investigation of the efficiency of the operation of complex machines and systems as required for the analysis and optimization of work processes. In addition to an evaluation, optimization possibilities can be derived from the identified data either for the work process itself, for example by means of macros or by targeted training and advanced training of operating personnel; however, an optimization of the program prompting itself is thereby enabled.

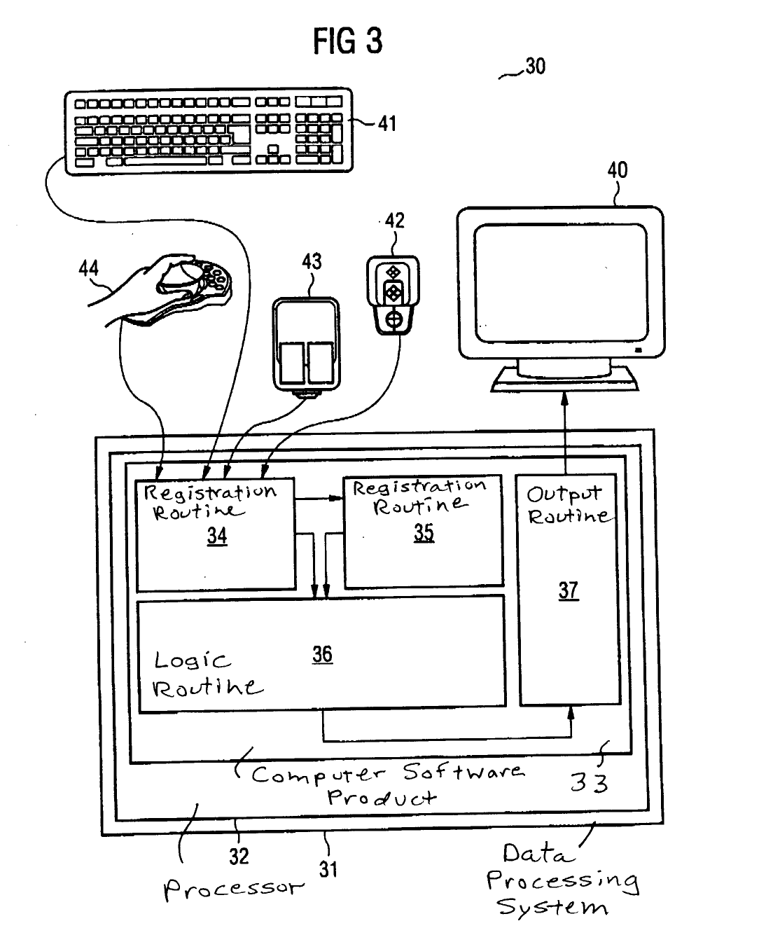

The block circuit diagram of FIG. 3 shows the components of an inventive device 30 for monitoring the operation of program-controlled devices. A data processing system 31 contains a processor 32 for the execution of computer programs having means for the execution of the inventive computer software product 33.

The computer software product 33 for monitoring the operation of program-controlled devices has a registration routine 34 for the registration of formal parameters that result from the employment of input aids by a user of the program-controlled device. Examples of such input aids are a keyboard 41, a magnifying glass 42 to be used with a graphics pad, a computer mouse 43, a force-sensitive input device (44) or the like. The formal parameters are acquired from values generated by the operating system due to the employment of the input aids.

The registration routine 35 for registering logical parameters triggered in programs of the program-controlled device due to the use of input aids determines the logical parameter in the program being used by the user at the moment that is triggered by the generation of a formal parameter in the registration routine 34.

The directly generated formal parameter as well as the indirectly effected logical parameter are registered in a monitoring profile in the logic routine 36. When a monitoring profile has been produced, then its content can be analyzed with the output routine 37 according to designated criteria and can be output on a data output device such as, for example, a data viewing device 40 or on data carriers, etc., as well.

Although modifications and changes may be suggested by those skilled in the art, it is the intention of the inventor to embody within the patent warranted hereon all changes and modifications as reasonably and properly come within the scope of his contribution to the art.

I claim as my invention:

1. A method for monitoring operation of a program-controlled device, comprising the steps of:
logging formal parameters entered into a program-controlled device resulting from use of an input aid and logging logical parameters triggered in a program of said program-controlled device as a result of said use of said input aid;
linking said formal parameters and said logical parameters to form a monitoring profile; and
determining output data for output from said monitoring profile according to at least one designated criterion.

2. A method as claimed in claim 1 comprising logging said formal parameters contemporaneously with entry thereof into said program-controlled device.

3. A method as claimed in claim 1 comprising logging said formal parameters and said logical parameters respectively combined with an indication of respective points in time at which said formal parameters were entered and said logical parameters were triggered.

4. A method as claimed in claim 1 comprising logging said formal parameters and logging said logical parameters together with a designation of a user of said input aid.

5. A method as claimed in claim 1 comprising including a designation of a type of said input aid in said formal parameters.

6. A method as claimed in claim 1 comprising including details describing said program-controlled device in said monitoring profile.

7. A method as claimed in claim 1 comprising determining said output data from said monitoring profile according to the designated criterion of a repeated triggering of identical logical parameters.

8. A method as claimed in claim 1 comprising determining said output data from said monitoring profile according to the designated criterion of an undo of previously triggered logical parameters.

9. A method as claimed in claim 1 comprising determining said output data from said monitoring profile according to the designated criterion of an attempted input of illegal value combinations in said formal parameters.

10. A method as claimed in claim 1 comprising determining said output data from said monitoring profile according to the designated criterion of a time span between triggering of two of said logical parameters.

11. A computer software product for monitoring operation of a program-controlled device, comprising:
a first registration routine for registering formal parameters resulting from usage of an input aid to enter said formal parameters into a program-controlled device;
a second registration routine for registering logical parameters triggered in programs of said program-controlled device as a result of said usage of said input aid;
a logic routine for linking said formal parameters and said logical parameters to form a monitoring profile; and
an output routine for generating output data from said monitoring profile according to at least one designated criterion.

12. A computer software product as claimed in claim 11 wherein said first registration routine registers said formal parameters contemporaneously with entry of said formal parameters into said program-controlled device.

13. A computer software product as claimed in claim 11 wherein said first registration routine registers said formal parameters together with an indication of respective points in time at which said formal parameters were entered into said program-controlled device, and wherein said second registration routine registers said logical parameters together with an indication of respective points in time at which said logical parameters were triggered in said programs of said program-controlled device.

14. A computer software product as claimed in claim 11 wherein said first registration routine and said second registration routine respectively register said formal parameters and said logical parameters combined with an indication of user of said input aid.

15. A computer software product as claimed in claim 11 wherein said first registration routine registers said formal parameters together with details identifying a type of said input aid.

16. A computer software product as claimed in claim 11 wherein said logic routine generates said monitoring profile to include details describing said program-controlled device.

17. A computer software product as claimed in claim 11 wherein said output routine determines said output data from said monitoring profile according to the designated criterion of a repeated triggering of identical logical parameters.

18. A computer software product as claimed in claim 11 wherein said output routine determines said output data from said monitoring profile according to the designated criterion of an undo of previously triggered logical parameters.

19. A computer software product as claimed in claim 11 wherein said output routine determines said output data from said monitoring profile according to the designated criterion of an attempted entry of illegal value combinations of said formal parameters.

20. A computer software product as claimed in claim 11 wherein said output routine determines said output data from said monitoring profile according to the designated criterion of a time span between triggering of two of said logical parameters.

21. An apparatus comprising:
a program-controlled device operated by a microprocessor connected to an input aid, said microprocessor executing at least one computer program dependent on usage of said input aid;
an output device connected to said microprocessor for displaying output data from said microprocessor; and
said computer program product programming said microprocessor to executed a first registration routine for registering formal parameters resulting from said usage of said input aid, and to execute a second registration routine for registering logical parameters triggered in said program resulting from said usage of said input aid, and to execute a logic routine for linking said formal parameters and said logical parameters to form a monitoring profile, and to execute an output routine for supplying said output data to said output device according to at least one designated criterion.

22. An apparatus as claimed in claim 21 wherein said first registration routine causes said microprocessor to log said formal parameters contemporaneously with entry of said formal parameters.

23. An apparatus as claimed in claim 21 wherein said first registration routine causes said microprocessor to log said formal parameters together with an indication of respective points in time at which said formal parameters were entered and wherein said second registration routine causes said microprocessor to log said logical parameters together with an indication of respective points in time at which said logical parameters were triggered.

24. An apparatus as claimed in claim 21 wherein said first and second registration routines causes said microprocessor to log said formal parameters and said logical parameters together with an indication of a user of said input aid.

25. An apparatus as claimed in claim 21 wherein said first registration routine causes said microprocessor to log said formal parameters together with a designation of a type of said input aid.

26. An apparatus as claimed in claim 21 wherein said logic routine causes said microprocessor to generate said monitoring profile with details describing said program-controlled device.

27. An apparatus as claimed in claim 21 wherein said output routine causes said microprocessor to determine said output data from said monitoring profile according to the designated criterion of a repeated triggering of identical logical parameters.

28. An apparatus as claimed in claim 21 wherein said output routine causes said microprocessor to determine said output data from said monitoring profile according to the designated criterion of an undo of previously triggered logical parameters.

29. An apparatus as claimed in claim 21 wherein said output routine causes said microprocessor to determine said output data from said monitoring profile according to the designated criterion of an attempted entry of illegal value combinations of said formal parameters.

30. An apparatus as claimed in claim 21 wherein said output routine causes said microprocessor to determine said output data from said monitoring profile according to the designated criterion of a time span between triggering of two of said logical parameters.
